(19) United States
(12) Patent Application Publication
(10) Pub. No.: US 2010/0289279 A1
(43) Pub. Date: Nov. 18, 2010

(54) Door Opener

(75) Inventor: Augustin Toma, Balingen (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: ASSA ABLOY SICHERHEITSTECHNIK GMBH, Albstadt (DE)

(21) Appl. No.: 12/594,772

(22) PCT Filed: Mar. 13, 2008
(86) PCT No.: PCT/EP08/02025

§ 371 Date: Apr. 1, 2010

(30) Foreign Application Priority Data
Apr. 4, 2007 (DE) 102007016327.6
Aug. 16, 2007 (DE) 102007038720.4

(51) Int. Cl. E05B 47/00; E05B 15/02

(52) U.S. Cl. 292/341.16

(57) ABSTRACT

An electrically actuatable door opener for releasing a door is provided. The electrically actuatable door opener comprises a swivelable pivot latch which is arranged for holding or releasing a lock latch, a catch lever, a latch lever which can be moved between a position blocking the pivot latch and a position releasing the pivot latch, and which is arranged in relation to the catch lever in such a way that it can be locked by the catch lever in the blocking position, and a positioning actuator through which the catch lever can be moved from the position locking the latch lever to the position releasing the latch lever. A method for unlocking a door opener is also provided.

The invention relates to an electrically actuatable door opener for releasing a door, comprising a swivelable pivot latch which is arranged for holding or releasing a lock latch, a catch lever, a latch lever which can be moved between a position blocking the pivot latch and a position releasing the pivot latch, and which is arranged in relation to the catch lever in such a way that it can be locked by the catch lever in the blocking position, and a positioning actuator through which the catch lever can be moved from the position locking the latch lever to the position releasing the latch lever. The invention further relates to a method for unlocking a door opener.

Electrically actuatable door openers have been known for a long time. They usually have a pivot latch with which, in the locked condition, a snap latch engages and is held therein. In the releasing condition, the pivot latch can swivel against the action of a spring force and the snap latch can thus be released. Generally, the releasing of the pivot latch takes place electrically and is triggered by a person by means of buttons or automatically by means of an access control system.

Usually, linear positioning actuators, which comprise an anchor that can move electromagnetically in a linear direction, are used for releasing the door opener. In the idle state, the anchor is freely movable and can be moved under the action of impacts or vibrations acting from outside. This can lead to the door opener releasing the pivot latch through manipulation from outside. Therefore, in order to reliably prevent unauthorized access, it is necessary that the electric door opener be as insensitive as possible to impacts from outside.

Furthermore, it is possible that the pivot latch is preloaded at the time of releasing the door opener, because, for example, a person is already pressing against the door. If an attempt is made to release the pivot latch of the door opener, it can become blocked while doing so, which will prevent the pivot latch from being released. Therefore, it is desirable that the door opener can be released even when the pivot latch is subjected to a preload.

It is further known from DE 103 60 225 B3 for example to arrange a motor with a speed-dependent, eccentrically acting mass on the door opener housing in such a way that moving, eccentrically held mass strikes against the safety catch or catch lever and opens the same with each rotation slightly further into the position releasing the latch lever. The motor or motor housing is thus fixed and only the eccentrically held mass which is responsible for the strikes on the catch lever will be acting.

Doors are increasingly provided lately with sealing elements for reasons of noise protection and/or insulation, so that a preload acting on the pivot latch of the door opener will increase continually. In view of the possible opening mechanisms as mentioned above, increasingly larger coil forces are required for example for coping with these rising preloads. This usually entails larger coils which need more space and also lead to an increased heat development. This is generally perceived to be disadvantageous.

It is therefore the object of the invention to provide a door opener which comprises an opening mechanism which is especially suitable for increased preloads. At the same time, the opening mechanism shall be especially compact and be integrated in a standard door opening housing.

This object is achieved with a door opener and a method for unlocking a door opener according to the independent claims. Preferred further developments are shown in the dependent claims.

The advantages of the invention lie in the low current consumption of the DC motor used, in the opening capability of the door under comparatively high preloads which is still audible to the extent that a user can perceive this noise development to offer an opening readiness of the door opener, and in the comparatively compact configuration of the door opener.

In accordance with the invention, the positioning actuator is arranged on the side of the catch lever and is arranged for transmitting oscillation movements to the catch lever. The positioning actuator within the terms of the invention concerns the means which causes a movement of the catch lever from the position locking the latch lever to the position releasing the latch lever. The positioning actuator comprises an electric motor for example for this purpose. In contrast to the state of the art, the positioning actuator is thus not arranged in a fixed or static manner on the housing of the door opener in accordance with the invention, but on sides of the catch lever. For this purpose, the positioning actuator is preferably connected in an indirect manner via transmission elements and especially directly with the catch lever. This leads to the consequence that the positioning actuator substantially moves together with the catch lever. As a result, the opening process of the door opener is initiated not by impact excitations for example, but by a modular unit which oscillates in its entirety and comprises at least the catch lever and the positioning actuator. An important advantage of this special arrangement lies, among other things, in an especially effective reduction of energy losses by occurring frictional forces in contrast to the door openers according to the state of the art, since the positioning actuator is used in its entirety for transmitting oscillations.

Preferably, the positioning actuator comprises a shaft and a shaft drive, with an asymmetrical distribution of mass being further provided on the output side of the shaft radially to the rotational movement for generating the oscillation movement. This special embodiment is characterized by its comparatively simple arrangement and its resulting high functional reliability for generating oscillations. The shaft drive makes the shaft perform a rotational movement about the shaft axis. Since an asymmetrical distribution of mass is provided in this embodiment on the output side of the shaft radially to this rotational movement, an imbalance is produced in a rotation of the shaft which causes the oscillation movement or vibrations.

A distribution of mass which is radially asymmetrical with respect to the rotational axis of the shaft is achieved in an especially simple way by a mass which is arranged in an eccentric manner on the driven side of the shaft. This embodiment is especially preferable in the respect that the extent of the eccentric distribution of mass can be controlled in an especially favorable manner by partly removing material from the mass for example. As a result, the adjustment of the door opener or an adjustment of the oscillations generated by the positioning actuator to individual conditions such as preloads acting on the door opener by various seals is possible in an especially favorable way.

The drive of the shaft preferably occurs by an electric drive. The use of a DC motor has proven to be especially reliable and thus preferable within the scope of the invention. One outstanding advantage of the DC motor over other types of motors is, among other things, the low power consumption and the comparatively compact configuration.

The arrangement of the shaft appropriately occurs in such a way that oscillations or vibrations caused by the positioning actuator also cause a movement of the catch lever which is suitable for unlocking the latch lever. This occurs in an especially effective way when the rotational axis of the shaft extends parallel to the pivoting axis of the catch lever. The oscillations caused by the positioning actuator then extend in the pivoting plane of the catch lever, thus enabling an especially effective utilization of the oscillation energy generated by the positioning actuator. This efficient utilization of the oscillation energy thus enables the use of comparatively “small” or low-power oscillation exciters or shaft drives for example, so that, among other things, the power needs of the door opener can be reduced or the spatial requirements for the shaft drive can be met especially well in the constricted spatial conditions in a door opener.

In an especially preferable embodiment, the door opener further comprises an oscillating bearing device through which the positioning actuator is held in a deflectable manner together with the catch lever. Such a bearing device is preferably a bent metal sheet which is rigidly connected via a connecting point with the door opener housing at one side for example. The bent metal sheet is further arranged in such a way that it comprises a region which is remote from the connecting point where the catch lever and/or the positioning actuator is/are arranged. The oscillating bearing device or the bent metal sheet can be directly connected for this purpose with the positioning actuator and/or the catch lever. Connection elements such as connection jaws and/or rubber and plastic elements for connecting the catch lever and/or the positioning actuator with the bearing device can also be present.

The bent metal sheet is flexible, so that the entirety consisting of catch lever and positioning actuator is movable or deflectable with respect to the door opener housing. The extent of the possible deflection is appropriately chosen in such a way that the catch lever can be moved at least from the position blocking the latch lever to the position releasing the latch lever. This arrangement ensures simultaneously that the oscillations generated by the positioning actuator are transmitted to the catch lever which is connected in a substantially rigid manner with the positioning actuator, and the positioning actuator and the catch lever are arranged indirectly via the bent metal sheet in the door opener or is connected with the same. A relevant advantage of this arrangement with the bearing device lies in an especially secure attachment of the positioning actuator and the catch lever in the door opener, especially with respect to functional integrity.

Preferably, the shaft is further arranged in such a way in the door opener that the rotational axis of the shaft extends perpendicular to the pivoting axis of the latch lever. This applies especially to an embodiment in accordance with the invention of a door opener with a bearing device capable of oscillation. This arrangement is especially compact and thus advantageous in respect of the limited available space. The shaft is arranged in a preferably lying or standing manner with respect to the installation position of the door opener.

A positioning actuator which is arranged for generating sinusoidal oscillation movements has proven to be especially suitable because the sinusoidal oscillation movement triggers an oscillation of the catch lever in an especially efficient way.

A door opener in accordance with the invention has exceptional unlocking properties whose positioning actuator is arranged for generating oscillations, whose amplitudes are lower than the release path between the catch lever and the latch lever. The release path designates the distance which the catch lever blocking the latch lever needs to be moved until the catch lever is in a position releasing the latch lever. This embodiment is advantageous in several respects. It is ensured in this manner on the other hand for example that the oscillation generated by the positioning actuator and transmitted to the catch lever is not so large that the catch lever will strike against the components of the door opener which limit the oscillation movement of the catch lever during every oscillation movement that is performed. This door opener is thus especially wear-proof. Furthermore, this embodiment further ensures especially well that a sliding friction effect is caused by the oscillation movements of the catch lever which are comparatively small in their amplitude but are therefore permanent, which sliding friction effect has clearly lower frictional values than the static application caused by the static friction in connection with solenoids. By choosing suitable angles, especially a suitable angle of pressure, between the catch lever and the latch lever in the locking point, a very easy opening of the door is ensured under this use of vibrations.

Preferably, the latch lever comprises a control chamfer in the engagement region with the catch lever, especially in a door opener in accordance with the invention. As a result of a pressure on the latch lever in the unlocking position, which is caused for example by counter-pressure against a door closed by the door opener, so that the lock latch presses against the pivot latch of the door opener in the opening direction, through which the pivot latch presses the latch lever into the unlocking position, the continuously oscillating catch lever runs along the control chamfer in the unlocking direction. The control chamfer thus ensures especially reliably that the catch lever will swing back completely during each oscillation movement or that the door can also be opened in any case upon activation of the positioning actuator.

Furthermore, an especially efficient transmission of the oscillation movement generated by the positioning actuator is further achieved when the positioning actuator is arranged for exciting the catch lever and especially also the bearing means capable of oscillation, especially the bending beams, in natural frequency. In this way, the catch lever and, if an oscillating bearing means such as a bending beam is present, also the oscillating bearing means will respond especially well to the oscillation excitation by the positioning actuator.

The object is further achieved by a method for unlocking a door opener as described above, comprising the steps of a) generation of oscillations on the side of the catch lever, b) transmission of the oscillations to the catch lever, and c) displacement of the catch lever controlled by the oscillations to a position releasing the latch lever. In contrast to previously known unlocking methods, the generation of oscillations thus occurs on the side of the catch lever and not on the side of the door opener housing in the unlocking method in accordance with the invention. The transmission of the oscillations triggered by the positioning actuator onto the catch lever is thus achieved in an especially effective manner and allows a reliable displacement of the catch lever to a position in which the door opener can finally be unlocked.

The invention is explained below in closer detail by reference to an embodiment shown schematically in the drawings, wherein:

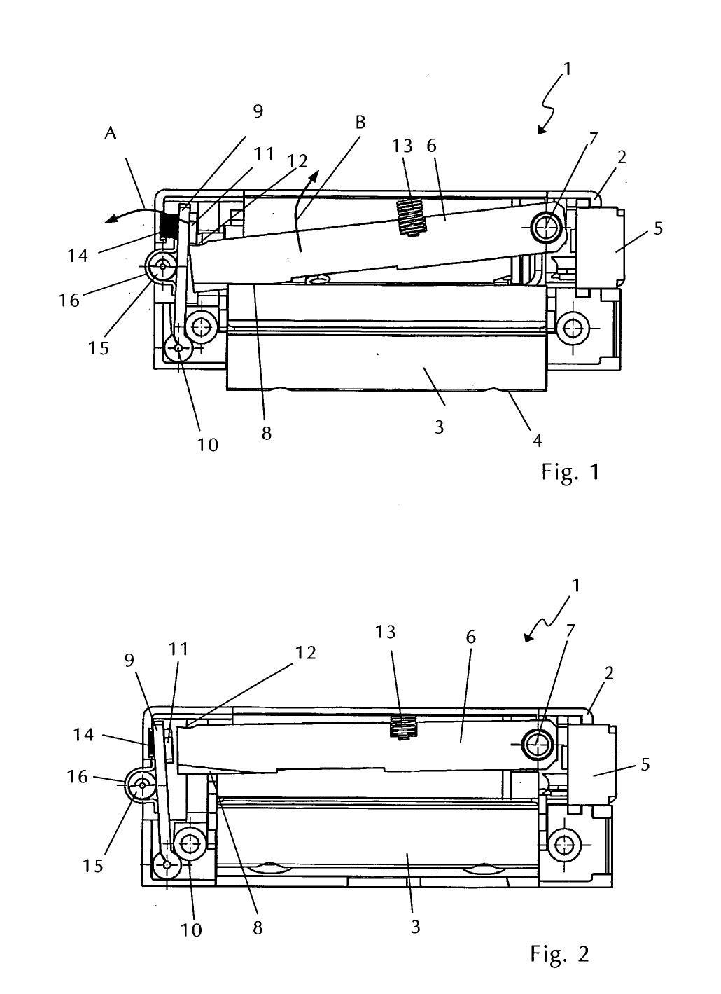

FIG. 1 shows a top view of a first door opener with a locked pivot latch;

FIG. 2 shows a top view of the door opener of FIG. 1 with released pivot latch;

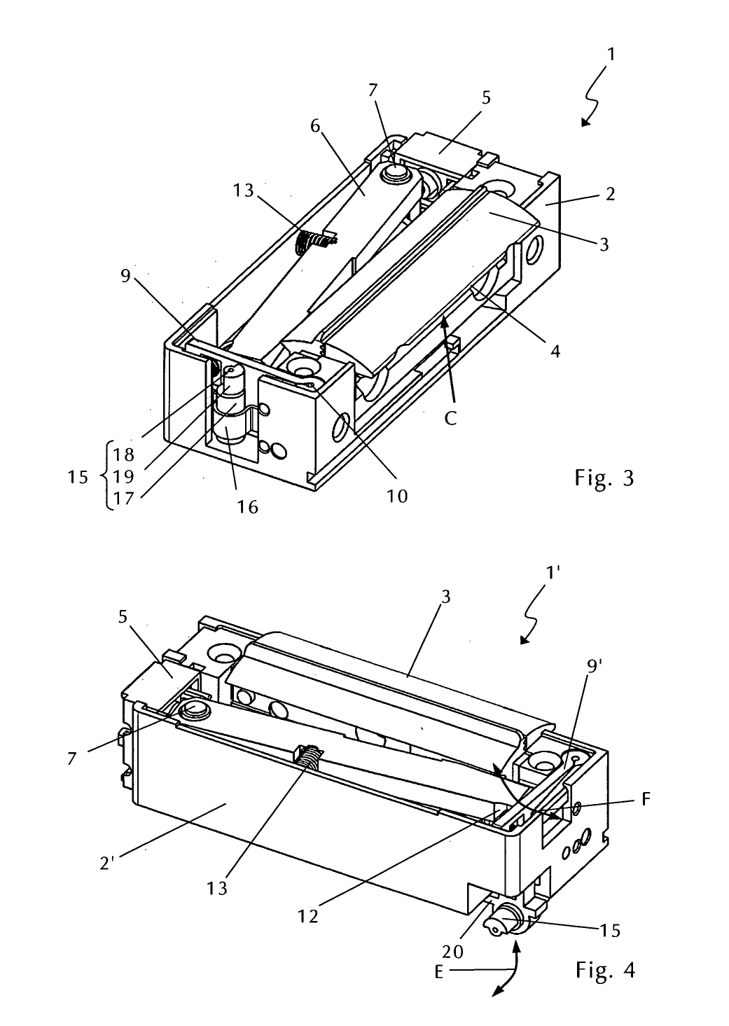

FIG. 3 shows a perspective oblique view of the door opener of FIG. 1 with locked pivot latch;

FIG. 4 shows a perspective oblique view of a second door opener with locked pivot latch;

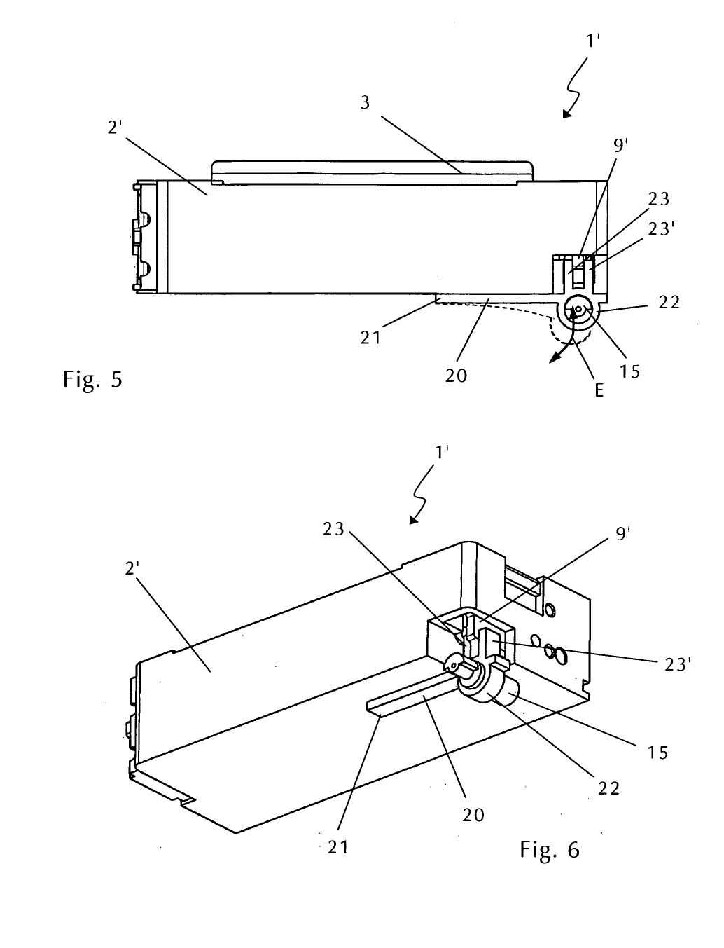

FIG. 5 shows a side view of the door opener of FIG. 4, and

FIG. 6 shows a perspective oblique view of the door opener of FIG. 4 on the region of the actuator.

FIGS. 1 to 3 show an electrically actuatable door opener 1 according to a first embodiment of the invention. Door opener 1 is usually installed in a fixed way in a door frame. It comprises a housing 2 on which a cover plate (not shown) is applied by means of screws in order to seal the interior of the door opener 1. The door opener 1 comprises a pivot latch 3 that is held against a spring force swivelably movable about a pivot latch axis in the housing 2 and can be swiveled in the direction of the interior of the housing. The pivot latch 3 is shown in FIG. 1 in a starting position and serves the purpose of holding or releasing a snap latch (not shown) arranged on a door or the like. For this purpose, the pivot latch 3 is provided with a projection 4, behind which the snap latch can lock. A terminal block 5 is provided on one side wall of the housing through which electric leads can be provided to a positioning actuator disposed in the door opener.

The latch lever 6 is attached in a pivoting manner to a latch lever axle 7 and can be swiveled about said axle. The pivoting axle of latch lever 6 extends orthogonally to the pivoting axle of the pivot latch 3. FIG. 1 shows the latch lever 6 in a position blocking the pivot latch 3 and strikes with a blocking region 8 against the pivot latch 3. The pivot latch 3 is thus blocked and can therefore not swivel into the door opener housing 2 as a result of a blockade of latch lever 6.

On the side opposite of the pivoting axis of the latch lever 6, a catch lever 9 is further provided which can be pivoted about a catch lever axle 10. The catch lever axle 10 extends parallel to the latch lever axle 7. The catch lever 9 blocks the latch lever 6 from performing a pivoting movement in the blocking position as shown in FIG. 1. For this purpose, the catch lever 9 comprises a blocking step 11 which is in engagement with a control chamfer 12 disposed on the latch lever 6.

In FIG. 2, the door opener 1 is shown in the released position in which the pivot latch 3 is pivoted for releasing a snap latch (not shown). For this purpose, the latch lever 6 and the catch lever 9 are in a released position. Accordingly, the catch lever 9 was pivoted in FIG. 2 starting from the latch lever 6 in FIG. 1 in the direction of arrow A in FIG. 1 and the latch lever 6 away from the pivot latch 3 in the direction of arrow B in FIG. 1.

In order to enable the latch lever 6 to pivot from the blocking position to the position releasing the pivot latch 3, the catch lever 9 must be moved in such a way that the control chamfer 12 of the latch lever 6 is no longer in engagement with the blocking step 11 of catch lever 9, so that the latch lever 3 can freely pivot with respect to catch lever 9. The pivoting of the catch lever 9 occurs against a force caused by the spring element 14, which means against arrow A of FIG. 1. The pivoting of the latch lever 6 occurs against a spring force which is caused by a spring element 13 coupled with the latch lever. The spring element 13 exerts a spring force on the latch lever 7 in the direction of the blocking position, which means against the arrow B in FIG. 1.

The movement of catch lever 9 from the position blocking the latch lever 6 to the position releasing the latch lever 6 against the force caused by the spring element 14 occurs by a positioning actuator 15 which is rigidly directly connected with the catch lever 9 via a bracket 16. The rigid coupling of the positioning actuator 15 with the catch lever 9 is a relevant fundamental idea of the invention. The positioning actuator 15 comprises a shaft 18, to which an eccentrically held mass 19 is fastened on the output side. A DC motor 17 is present for driving the shaft. A rotational movement of the shaft 18 makes the positioning actuator 15 vibrate and oscillate, and thus also the catch lever 9 rigidly connected with the positioning actuator 15, as a result of the eccentrically held mass 19. When the positioning actuator 15 is activated, or in detail when the shaft 18 driven by the DC motor 17 starts to rotate, through which the eccentrically held mass 19 is made to rotate, the positioning actuator starts to oscillate or vibrate as a result of the rotation of the eccentrically held mass 19, with the oscillation or vibration plane extending substantially orthogonally to the rotational axis. As a result of the direct and rigid connection of the catch lever 9 with the positioning actuator 14, the catch lever 9 is made to oscillate or vibrate through the rotating eccentric mass 19 of the positioning actuator 15. The oscillation movement or the vibration of the catch lever 9 is substantially determined by the catch lever axle, so that the catch lever 9 oscillates predominantly in the direction of double arrow D in FIG. 1.

When a pressure is exerted on the door in the opening direction for opening a door blocked by the door opener 1 (not shown), the lock latch (not shown) which is in engagement with the pivot latch 3 presses in the direction of arrow C in FIG. 3 on the pivot latch 3. It is blocked by the latch lever according to FIGS. 1 and 3, so that the pressure exerted on the pivot latch 3 via the latch lever 6 on the catch lever 9 which is in engagement with the latch lever 6 can be transmitted. When the positioning actuator 15 is activated, so that the catch lever 9 oscillates substantially in the direction of the double arrow D in FIG. 1, the blocking step 11 arranged on the catch lever 9 slides along the control chamfer 12 disposed on the latch lever 6 towards the face side end of the latch lever 6 and releases the same as a result. The angle of the control chamber 12 to the blocking step 11 is of central significance. On the one hand, the angle must be chosen in such a way that the blocking step 11 will slide along the control chamfer by mere pressing against the locked door. On the other hand, the control chamfer 12 most extend in such a pronounced manner that the oscillating blocking step 11 is able to slide along the control chamfer 12 and will not oscillate back to its previous position with each oscillating movement towards the latch lever 6, through which a motion of the catch lever 9 into the position releasing the latch lever 6 would otherwise not be possible.

FIGS. 4 to 6 show an electrically actuatable door opener 1′ according to a second embodiment of the invention with a housing 2′. In accordance with FIG. 4, the latch lever 6 is in the position blocking the pivot latch 3 and is blocked by the catch lever 9′. The relevant difference to the first embodiment of the door opener 1 is in the oscillating bearing of the modular unit consisting of catch lever 9′ and the positioning actuator 15 via a bent metal sheet 20.

The bent metal sheet 20 comprises for this purpose a beam-like body extending longitudinally, in the end region of which it is rigidly connected with the door opener housing 2′. This can occur for example by a solder joint, screwed joint, etc. At the end opposite of the end region of the longitudinally extending body, the bent metal sheet 20 comprises a receptacle 22 for the positioning actuator 15 which is arranged integrally with the bent metal sheet 20. Furthermore, two accommodating jaws 23 and 23′ are present which are arranged integrally with the bent metal sheet and which enclose a partial region of the catch lever 9′ and are used for fastening the catch lever 9′ on the bent metal sheet 20. The positioning actuator 15 is thus rigidly connected via the bent metal sheet 20 with the catch lever 9′. The accommodating jaws 23/23′ can be provided with rubber elements alternatively or in addition.

An activation of the positioning actuator 15 allows the bent metal sheet 20 to oscillate in the direction of the double arrow E in FIG. 5. The oscillations of the positioning actuator 15 are transmitted onto the catch lever 9′ because the positioning actuator 15 is rigidly connected with the catch lever 9′ via the bent metal sheet 20, so that the same will oscillate in the direction of double-arrow F according to FIG. 4. The further sequence of an opening process is analogous to the processes explained above with respect to the first embodiment of door opener 1.

1. An electrically actuatable door opener for releasing a door, comprising a swivelable pivot latch which is arranged for holding or releasing a lock latch, a catch lever, a latch lever which can be moved between a position blocking the pivot latch and a position releasing the pivot latch, and which is arranged in relation to the catch lever in such a way that it can be locked by the catch lever in the blocking position, and a positioning actuator through which the catch lever can be moved from the position locking the latch lever to the position releasing the latch lever, wherein the positioning actuator is arranged on the side of the catch lever and is arranged for transmitting oscillation movements to the catch lever.

2. A door opener according to claim 1, wherein the positioning actuator comprises a shaft and a shaft drive, and an asymmetrical distribution of mass is provided on the output side of the shaft radially to the rotational movement for generating the oscillation movement.

3. A door opener according to claim 2, wherein an eccentrically arranged mass is present on the output side of the shaft.

4. A door opener according to claim 2, wherein the shaft drive is a DC motor.

5. A door opener according to claim 2, wherein the rotational axis of the shaft extends parallel to the pivoting axis of the catch lever.

6. A door opener according to claim 1, wherein a bearing means capable of oscillation is present on the positioning actuator, through which the positioning actuator is held to be deflectable together with the catch lever.

7. A door opener according to claim 1, wherein the rotational axis of the shaft extends perpendicular to the pivoting axis of the latch lever.

8. A door opener according to claim 1, wherein the positioning actuator is arranged for generating sinusoidal oscillation movements.

9. A door opener according to claim 1, wherein the positioning actuator is arranged for generating oscillations whose amplitudes are lower than the releasing path between the catch lever and the latch lever.

10. A door opener according to claim 6, wherein the positioning actuator is arranged for excitation in natural frequency of the catch lever and the bearing means.

11. A method for unlocking a door opener according to claim 1, comprising the following steps:
a) generation of oscillations on the side of the catch lever;
b) transmission of the oscillations onto the catch lever, and
c) oscillation-controlled displacement of the catch lever to a position releasing the latch lever.

12. A door opener according to claim 6, wherein the bearing means is a bent metal sheet.
